(19) United States
(12) Patent Application Publication
(10) Pub. No.: US 2009/0130383 A1
(43) Pub. Date: May 21, 2009

(54) Biaxially Oriented Polystyrene Film Containing Small Rubber Particles and Low Rubber Particle Gel Content

(76) Inventor: Ludovic Harelle, Uniontown, OH (US)

Correspondence Address: The Dow Chemical Company, Intellectual Property Section, P.O. Box 1967, Midland, MI, 48641-1967, US

(21) Appl. No.: 11/988,409

(22) PCT Filed: Jul. 27, 2006
(86) PCT No.: PCT/US06/29492

§ 371 Date: Jan. 7, 2008

Related U.S. Application Data
(60) Provisional application No. 60/703,385, filed on Jul. 28, 2005.

(51) Int. Cl. B32B 3/24; C08L 9/06; B32B 5/16

(52) U.S. Cl. 428/131; 525/99; 428/327; 428/206

(57) ABSTRACT

A biaxially oriented film has a machine direction-orientation (MDO) ratio of more than 1.2 and a transverse direction orientation (TDO) ratio of 2.0 or less, where the MDO ratio is greater than the TDO ratio; where the film contains a polymer composition containing a first high impact polystyrene (HIPS) component with a block copolymer grafted to polystyrene, a rubbery conjugated diene content of one to seven weight percent based on first HIPS weight, less than 10 weight-percent gel concentration, an average rubber particle size of between one and 0.01 micrometers, about 40 to about 90 volume percent of the rubber particles have diameters of less than about 0.4 microns and from about 10 to about 60 volume percent of the rubber particles have diameters between about 0.4 and about 2.5 microns, a majority of rubber particles with a core/shell morphology and a concentration that accounts for 30 to 100 weight-percent of the total polymer composition weight and one to five weight-percent rubbery diene based on total polymer composition weight. The film can also contain up to 70 weight percent of a general purpose polystyrene and up to 20 weight-percent of a second HIPS component that is different from the first HIPS component, both based on total polymer composition weight. The polymer composition accounts for at least 95 weight-percent of the film, with the balance of the film weight being additives.

### CROSS REFERENCE STATEMENT

This application claims the benefit of U.S. Provisional Application No. 60/703,385, filed Jul. 28, 2005.

### BACKGROUND OF THE INVENTION

1. Field of the Invention

The present invention relates to a biaxially oriented rubber-reinforced polystyrene film that has a preferential orientation in the machine direction and a shrink-label film comprising such a polystyrene film.

2. Description of Related Art

Shrink labels generally fall into two categories: roll-on shrink-on (ROSO) labels and sleeve-type labels (sleeve labels). ROSO labels are film sheets that wrap around a container. Sleeve labels are tubular in configuration and fit around a container by placement over the container. Application of heat to a shrink label that is around a container causes the label to shrink and conform to the container.

To conform to a container, each type of label must shrink preferentially (that is, to a greater extent than in any other direction) in the direction extending circumferentially around the container. ROSO films reside on a container with the machine direction (MD) of the film extending circumferentially around the container. Hence, ROSO films primarily shrink in the film's machine direction (MD) due to preferential machine direction orientation (MDO). In contrast, sleeve labels typically reside on a container with the label's transverse direction (TD) extending circumferentially around the container. Hence, sleeve labels shrink primarily in the film's transverse direction (TD) due to preferential transverse direction orientation (TDO).

ROSO labels are particularly desirably over sleeve labels because they entail less processing and are less costly to produce. ROSO labels are typically in roll form resulting from printing onto an oriented film in a continuous web process. In contrast, sleeve labels, while also available in roll form, require printing, cutting and gluing into sleeves prior to rolling into roll form, complicating the manufacturing process and increasing manufacturing costs for sleeve labels relative to ROSO labels. Furthermore, orienting films in the TD for sleeve labels tends to be more expensive than orienting films in the MD for ROSO labels. Additionally, ROSO application of ROSO labels to containers is typically a faster process than application of sleeve labels.

While ROSO labels offer advantages in production speed, sleeve labels historically have enjoyed an advantage in extent of shrinkage around a container. Sleeve labels typically shrink up to 70 percent (%) around the circumference of a container. In contrast, ROSO films historically demonstrate up to about 20% shrinkage around the circumference of a container. Lower shrinkage in the ROSO labels is mainly due to: (1) predominant use of oriented polypropylene (OPP), a crystalline polymer, for the film and (2) a limitation on the stress allowed on a glue seam holding the label in place (wrapped) around a container—too much stress on the glue seam can cause the label to shift on the container or, in an extreme case, cause the label to unwrap from around the container. Sleeve labels, which either have no glue joint or have a glue joint that is extensively cured prior to application to a container, can tolerate a greater extent of stress during shrinkage.

Sleeve labels historically enjoy more extensive shrinkage and therefore have conformed better to contoured containers than ROSO labels. However, in view of the production advantages of ROSO labels, it is desirable to identify an oriented film suitable for preparing a ROSO label that can shrink circumferentially around a container to a greater extent than current ROSO labels (that is, more comparable to sleeve labels) but without the detriment of failure at the glue joint of the label.

Polystyrene (PS) is a particularly desirable polymer for shrink labels. Shrink label films of polypropylene (PP), for example, typically shrink only up to about 20% in any direction at a temperature below 120° C. The crystalline nature of PP requires heating above the PP's crystalline melt temperature to release additional-orientation. In contrast, PS-based shrink label films only need to exceed the polymer's glass transition temperature (which generally is lower than PP's crystalline melt temperature) due to its amorphous character. Therefore, PS films can desirably provide greater shrink at lower processing temperatures than PP films.

Additionally, PS retains a higher surface energy after corona treatment (necessary to render the surface of a polymer film suitable for printing) for extended periods of time relative to PP. Therefore, unlike PP films, corona treatment of PS films can occur during manufacture rather than just prior to printing into labels.

In contrast to copolyester and polyvinyl chloride (PVC) films, use of PS films facilitate bottle and label recyclability, as the lower density allows the label to be easily separated from the higher density (for example, polyester) bottles. Furthermore, the lower PS density advantageously provides a higher film yield, or more area/lb. of film. Higher density labelstock, such as copolyester or PVC films, do not provide similar advantages.

Polystyrene-based shrink label films often include a high impact polystyrene (HIPS) component in order to improve label toughness (for example, tear resistance). However, rubber particles in a typical HIPS range have an average particle size of greater than one micrometer (see, for example, U.S. Pat. No. 6,897,260, column 4, lines 26-27). Large rubber particles tend to decrease clarity of a label film, interfering with the use of the film for reverse side printing (printing on the side of a label film proximate to the container so that it is readable through the film) as well as with viewing of the container or product through the label. Typical HIPS also contains greater than 7 percent rubber based on total HIPS weight. High concentrations of rubber can hinder the printability of a film, decrease clarity of a film, reduce dimensional stability and undesirably increase gel amount in a final film.

It is desirable to have an oriented PS film that is suitable for ROSO label applications. It is further desirable for the film to contain a high impact polystyrene of a type that has smaller rubber particles and lower rubber concentrations than that of typical HIPS in order to achieve film toughening without hindering printability or clarity of the film. It is still further desirable if such a film can serve as a ROSO label that demonstrates circumferential shrink around a container similar to sleeve labels.

### BRIEF SUMMARY OF THE INVENTION

The present invention advances shrink-label art by providing a biaxially oriented polystyrene-based film suitable for use as a ROSO label and that contains HIPS with a rubber particle size and rubber concentration below that of typical HIPS. The present invention can provide a rubber-reinforced polystyrene film, and ROSO label comprising such a film, that surprisingly has one or more of high clarity, improved MD shrink over conventional ROSO labels, and a combination of high shrink and low oriented release stress relative to conventional ROSO labels.

In a first aspect, the present invention is a biaxially oriented film comprising a polymer composition, said polymer composition consisting of: (a) a first high impact polystyrene (HIPS) component having: (i) a block copolymer of styrene and a rubbery conjugated diene, wherein the copolymer is grafted to a polystyrene; (ii) optionally, two weight-percent or more and 8 weight-percent or less of a rubber homopolymer based on first HIPS component weight; (iii) a total rubbery conjugated diene content of one weight percent or more and seven weight percent or less based on total weight of the first HIPS component; (iv) less than 10 wt % gel concentration by methyl ethyl ketone/methanol extraction; (v) an average rubber particle size of less than 1.0 micrometers and 0.01 micrometers or more; (vi) about 40 to about 90 volume percent of the rubber particles with diameters of less than about 0.4 microns and from about 10 to about 60 volume percent of the rubber particles with diameters between about 0.4 and about 2.5 microns; (vii) a majority of rubber particles with a core/shell morphology; (viii) a concentration that accounts for 100 percent by weight (wt %) or less and 30 wt % or more relative to the polymer composition weight and accounts for one or more and five or less percent by weight of rubbery diene weight relative to total composition weight; and (b) a general purpose polystyrene having a weight-average molecular weight of more than 200,000 grams per mole and 350,000 grams per mole or less and that is present at a concentration of zero wt % or more and 70 wt % or less relative to the polymer composition weight; and (c) a second HIPS component different than (a) and that is present at a concentration of zero wt % or more and 20 wt % or less relative to the polymer composition weight; wherein, the total combination of (a), (b) and (c) accounts for 100 wt % of the polymer composition; the polymer composition accounts for at least 95 wt % of the biaxially oriented film weight with the balance to 100 wt % selected from additives; and wherein the film has a MDO ratio of more than 1.2 and a TDO ratio of 2.0 or less and wherein the MDO ratio is greater than the TDO ratio.

In a second aspect, the present invention is a shrink label comprising a biaxially oriented polymer film of the first aspect wherein the film has printing on one or both sides.

### DETAILED DESCRIPTION OF THE INVENTION

Films of the present invention comprise a polymer composition comprising a first HIPS component and optionally a general purpose polystyrene (GPPS), a second HIPS component, or both a GPPS and a second HIPS component. The combination of first HIPS component, GPPS and second HIPS component account for 100 percent by weight (wt %) of the polymer composition. The polymer composition desirably accounts for 95 wt % or more, preferably 97 wt % or more, and can comprise 100 wt % of the total film weight. When the polymer composition is less than 100 wt % of the film weight, the balance to 100 wt % consists of additives, including any additives that may be part of the first HIPS component, GPPS, and second HIPS component. Additives include standard fillers and standard processing aids such as plasticizers.

The first HIPS component is a styrene polymer containing a grafted rubber component. Grafting of a rubber component into a polystyrene tends to increase toughness and mechanical strength of the polystyrene. Binding the rubber to the polystyrene through grafting has technical advantages over simply blending polystyrene with a rubber component. Binding the rubber generally provides a material with a higher modulus and equivalent impact strength with a lower rubber content than a simply blended rubber. Graft the rubber component into the styrene polymer by combining the rubber component with styrene monomers, typically by dissolving the rubber in styrene monomers prior to polymerizing the styrene monomers. Polymerizing the styrene monomers then produces a matrix of polystyrene containing rubber grafted to styrene polymers.

The polystyrene matrix typically has a sufficiently high weight average molecular weight (Mw) to provide a desirable level of processability and mechanical properties in the composition, which is typically a Mw of at least 100,000, preferably at least about 120,000, more preferably at least about 130,000 and most preferably at least about 140,000 grams per mole (g/mol). The polystyrene typically has a Mw that is less than or equal to about 260,000, preferably less than or equal to about 250,000, more preferably less than or equal to about 240,000 and most preferably less than or equal to about 230,000 g/mol in order to provide sufficient processability. Measure polystyrene matrix Mw by using gel permeation chromatography using a polystyrene standard for calibration.

The rubber component is a copolymer of a rubbery conjugated diene and styrene (rubber copolymer) or a blend comprising both the rubber copolymer and a minor amount of a rubbery conjugated diene homopolymer (rubber homopolymer).

The conjugated diene in both rubbers is typically a 1,3-alkadiene, preferably butadiene, isoprene or both butadiene and isoprene, most preferably butadiene. The conjugated diene copolymer rubber is preferably a styrene/butadiene (S/B) block copolymer. Polybutadiene is a desirable rubber homopolymer.

The rubber copolymer desirably has a Mw of 100,000 g/mol or more, preferably 150,000 g/mol or more and desirably 350,000 g/mol or less, preferably 300,000 g/mol or less, more preferably 250,000 g/mol or less. Measure Mw using Tri Angle Light Scattering Gel Permeation Chromatography.

The rubber copolymer also desirably has a solution viscosity in the range of from about 5 to about 100 centipoise (cP) (about 5 to about 100 milliPascal-second (mPa*s)), preferably from about 20 to about 80 cP (about 20 to about 80 mPa*s); and cis content of at least 20%, preferably at least 25% and more preferably at least about 30% and desirably 99% or less, preferably 55% or less, more preferably 50% or less. Buna BL 6533 T brand rubber and other similar rubbers are desirable examples of rubber copolymers.

Including rubber homopolymer with a rubber copolymer when preparing the first HIPS component can contribute to the mechanical performance of the HIPS polymer by enhancing the amount of elongation at rupture. Suitable rubber homopolymers desirably have a second order transition temperature of zero degrees Celsius (° C.) or less, preferably −20° C. or less. Preferably, the rubber homopolymer has a solution viscosity in the range of about 20 to about 250 cP (about 20 to about 250 mPa*s), more preferably from about 80 cP to 200 cP (about 80 to about 200 mPa*s). The rubber homopolymer desirably has a cis content of at least about 20%, preferably at least about 25% and more preferably at least about 30% and desirably about 99% or less, preferably 55% or less, more preferably 50% or less. Desirably rubber homopolymers have a Mw of 100,000 g/mol or more, more preferably 150,000 g/mol or more and desirably 600,000 g/mol or less, preferably 500,000 g/mol or less. Measure Mw by Tri Angle Light Scattering Gel Permeation Chromatography). An example of a suitable rubber homopolymer is Diene™ 55 brand rubber (Diene is a trademark of Firestone).

Rubber homopolymer, when present, will typically comprise at least about 2 wt %, preferably at least 4 wt %, more preferably at least 6 wt % and most preferably at least 8 wt % based on total rubber weight in the HIPS polymer. In order to avoid unnecessarily low transparency or clarity, the rubber homopolymer content is desirably 25 wt % or less, preferably 20 wt % or less, more preferably 16 wt % or less and most preferably 12 wt % or less based on total rubber weight.

The first HIPS component has a total diene-component content from the rubber component (that is, content arising from rubbery conjugated diene of both rubber copolymer and rubber homopolymer when preparing the first HIPS component) of about one wt % or more, preferably 1.5 wt % or more, more preferably 2 wt % or more, still more preferably 2.5 wt % or more and most preferably 3 wt % or more based on weight of the first HIPS component. Rubber concentrations below about 1 wt % fail to obtain a desirable level of mechanical strength and toughness. In order to provide desirable transparency, the rubber concentration is typically 7 wt % or less, preferably 6 wt % or less, more preferably 5 wt % or less, even more preferably 4 wt % or less, based on total weight of the first HIPS component.

Without being bound by theory, lower rubber concentrations, such as 7 wt % or less based on HIPS, is desirable to avoid extensive crosslinking in the rubber particle and reduce the likelihood of gel formation. While some crosslinking in the rubber is desirable to maintain the integrity of the rubber during shearing in manufacture, extensive crosslinking can hinder a rubber particle's ability to deform during film orientation. Clarity and transparency of a film increase as rubber particles deform into particles with higher aspect ratios. Rubber particles with less crosslinking tend to deform and retain their deformed shape more readily than higher crosslinked rubber particles, making the lower crosslinked particles more amenable to clear and transparent films. Defining a specific rubber concentration where crosslinking becomes undesirably extensive is difficult since it depends on specific processing conditions. Even so, rubber concentrations of 12 wt % or more based on HIPS weight, tend to have undesirably extensive crosslinking.

Similarly, without being bound by theory, films of the present invention likely benefit from having a lower gel formation as a result of a lower rubber concentration. Gels form by extensive crosslinking of rubber agglomerates which fail to shear into small particles during film manufacture. Crosslinked gel agglomerates can cause difficulty in film manufacture, for instance by causing bubble breaks in a blown film process. Gel agglomerates also have a detrimental effect on film quality, appearing as non-uniform defects in the film and causing dimples in films wound over the agglomerate particle. The dimples tend to pose problems during printing by precluding ink reception on dimpled spots of a film's surface.

The first HIPS component further has a gel concentration according to a methyl ethyl ketone/methanol extraction of less than 10 wt %, relative to total first HIPS component weight. Such a low gel concentration is desirable to maximize film clarity. Conduct the methyl ethyl ketone/methanol extraction similar to the method of Unexamined Japanese Patent Application Kokai No. P2000-351860A for determining gel concentration. In essence, dissolve a sample of first HIPS (sample weight is W1) into a mixed solvent methyl ethyl ketone/methanol (10:1 volume ratio) at room temperature (about 23° C.). Separate the insoluble fraction by centrifugal separation. Isolate and dry the insoluble fraction. The weight of the isolated and dried insoluble fraction is W2. The gel concentration in wt % is 100×W2/W1.

The first HIPS component has a volume average rubber particle size of less than one micrometer (μm), preferably 0.5 μm or less and generally 0.01 μm or more, preferably 0.1 μm or more and more preferably 0.3 μm or more. Such a volume average rubber particle size is in contrast to conventional HIPS materials, which have an average rubber particle size of at least one μm (see, for example, U.S. Pat. No. 6,897,260B2, column 4, lines 22-34; incorporated herein by reference). Small rubber particle sizes are desirable because they tend to produce films with higher clarity and lower haze than films with larger rubber particles. However, rubber particles below 0.01 μm tend to contribute little to the durability of a composition despite their transparency and clarity.

The rubber particles in the first HIPS component have a broad particle size distribution where the majority of the particles are smaller and only a limited amount of particles are larger. In particular, it is desirable to have a distribution where from about 40 to about 90 volume percent (vol %) of the particles have diameters less than about 0.4 μm. Correspondingly, it is desirable to have a distribution of relatively large particles where from about 10 to about 60 vol % of the particles have diameters greater than about 0.4 μm and less than about 2.5, preferably from about 15 to 55 vol % and more preferably from about 20 to about 50 vol % of the particles have diameters greater than or equal to about 0.5 μm and less than or equal to about 2.5 μm. Preferably, for this component of relatively large particles, the specified percentage amounts of the particles have diameters less than about 2 μm, more preferably about 1.5 μm or less, still more preferably about 1.2 μm or less, even more preferably about 1 μm or less.

Rubber particle size is a measure of rubber-containing particles, including all occlusions of monovinylidene aromatic polymer within the rubber particles. Measure rubber particle size with a Beckham Coulter: LS230 light scattering instrument and software. The manufacturer's instructions and literature (JOURNAL OF APPLIED POLYMER SCIENCE, VOL. 77 (2000), page 1165, “A Novel Application of Using a Commercial Fraunhofer Diffractometer to Size Particles Dispersed in a Solid Matrix” by Jun Gao and Chi Wu) provide a method for measuring rubber particle size with the Beckham Coulter. Preferably, using this equipment and software, the optical model for calculating the rubber particle size and distribution statistics is as follows: (i) Fluid Refractive Index of 1.43, (ii) Sample Real Refractive Index of 1.57 and (iii) Sample Imaginary Refractive Index of 0.01.

The majority of the rubber particles, preferably 70% or more, more preferably 80% or more, more preferably 90% or more of the rubber particles in the first HIPS component will have a core/shell particle morphology. Core/shell morphology means that the rubber particles have a thin outer shell and contain a single, centered occlusion of a matrix polymer. This type of particle morphology is commonly referred to as “single occlusion” or “capsule” morphology. In contrast, the terms “entanglement” or “cellular” morphology refer to various other, more complex rubber particle morphologies that include “entangled”, “multiple occlusions”, “labyrinth”, “coil”, “onion skin” or “concentric circle” structures. Determine the percentage of rubber particles having a core/shell morphology as a numerical percentages from 500 particles in a transmission electron micrograph photo of the first HIPS component.

Core-shell particles in the first HIPS component are crosslinked to the degree that they will stretch but not break under shear fields (that is, during an orientation process). Their thin walls (as a result of high compatibility coming from the presence of copolymer rubbers) will become even thinner but remain intact to provide the needed mechanical and tensile strength properties. Presumably, upon film orientation, the oriented rubber morphology is very close to a co-continuous distribution of very thin ribbons of rubber, possibly as a result of a low amount of multi-occlusion particles in the system (cellular morphology). The very thin shell walls have better light transmittance than would result with thicker walls and definitely better than if there were residual cellular or multi-occlusion particles, which do not distribute as very thin ribbons upon orientation.

The first HIPS component may be free of or contain other additives such as mineral oil or other plasticizers. Appropriate amounts of mineral oil can improve mechanical properties such as elongation at rupture. The first HIPS component will typically contain at least about 0.4 wt %, preferably 0.6 wt % or more, more preferably 0.8 wt % or more and still more preferably 1 wt % or more mineral oil based on total weight of the first HIPS component. In order to obtain a desirable clarity, the first HIPS component will generally contain less than about 3 wt %, preferably 2.8 wt % or less, more preferably 2.6 wt % or less and most preferably 2.4 wt % or less mineral oil based on total weight of the first HIPS component.

A suitable material for use as the first HIPS component is that described in U.S. Pregrant Publication 2006-0084761 entitled: IMPROVED RUBBER MODIFIED MONOVINYLIDENE AROMATIC POLYMERS AND THEMOFORMED ARTICLES.

The first HIPS component differs from standard, mass or solution polymerized HIPS in that the rubber particle size distribution is relatively broad and the majority of the rubber particles have a core-shell morphology. In contrast, conventional HIPS resins tend to have a relatively narrow particle size distribution and have predominantly or at least a larger percentage of cellular, multi-occlusion particle structure.

Films of the present invention contain 100 wt % first HIPS component or less and 30 wt % or more first HIPS component, based on total polymer composition weight. Films of the present invention may contain 80 wt % or less, or 60 wt % or less and 50 wt % or more, or 75 wt % or more of the first HIPS component, based on total polymer composition weight.

Total rubber content (based on total diene content from copolymer and homopolymer) arising from the first HIPS component in the films of the present invention is 2 wt % or more, preferably 3 wt % or more and 5 wt % or less based on total film weight.

The polymer composition of the present film can contain a crystal polystyrene, also called a general purpose polystyrene (GPPS). GPPS for use in the present invention desirably has a Mw of more than 200,000 g/mol, preferably 280,000 g/mol or more and 350,000 g/mol or less, preferably 320,000 g/mol or less. Measure Mw according to gel permeation chromatography. The GPPS desirably has a melt flow rate (MFR) of one or more, preferably 1.2 grams per 10 minutes (g/10 min) or more and desirably 3 g/10 min or less, preferably 2 g/10 min or less. Measure MFR according to ASTM method D1238. The GPPS may be free of or may contain plasticizing agents such as mineral oil, ethylene or propylene glycol, phthalates, or styrenic oligomers. Plasticizing agents, when present, are typically present at a concentration of 4 wt % or less, preferably 3 wt % or less, based on GPPS weight. When present, the plasticizing agent typically comprises one wt % or more of the GPPS weight.

While films of the present invention can be free of GPPS, the films can include up to 70 wt % GPPS based on polymer composition weight. Desirable ranges of GPPS in the films of the present invention include 20 wt % or more, preferably 25 wt % or more and 70 wt % or less, preferably 65 wt % or less based on polymer composition weight.

Examples of suitable GPPS include STYRON® 665 general purpose polystyrene (STYRON is a trademark of The Dow Chemical Company), STYRON 663 and STYRON 685D.

The polymer composition of the present film can also contain a second HIPS component, which can be any HIPS component that is different from the first HIPS component. The second HIPS component can be in addition to or instead of the GPPS component. Films of the present invention can also be free of the second HIPS component. The second HIPS component typically comprises up to 20 wt % of the film weight when GPPS is present and up to 10 wt % of the film weight when GPPS is absent. Beyond these limits, the films tend to have undesirably low clarity.

Similarly, the total rubber concentration in the present film (from the first HIPS component and, if present, the second HIPS component) is desirably less than 10 wt %, preferably 8 wt % or less, more preferably 7 wt % or less and can be 6 wt % or less based on the film weight. Oriented films with 10 wt % rubber or more can have undesirably low film clarity and printability and tend to have low dimensional stability that can, for example, require cooling during shipping to prevent premature shrinkage.

The second HIPS component is useful for enhancing film toughness even beyond that of the first HIPS component. However, incorporation of high amounts of the second HIPS component can tend to obscure the clarity and transparency of the films. This can be detrimental when a clear film is desirable, but beneficial for application where clarity is not a necessity but a high measure of film toughness is.

Films of the present invention have biaxial orientation with preferential machine direction orientation (MDO). Preferential MDO means that orientation is greater in the machine direction than in the transverse direction (TD). TD is perpendicular to the direction of film transport during extrusion or blowing of the film. MD is along the direction of film transport during extrusion or blowing of the film. Preferential MDO causes a film of the present invention to shrink primarily in the MD upon application of heat.

Films of the present invention have a MDO ratio (ratio of oriented length to un-oriented length in the MD) of greater than 1.2, preferably 1.5 or more, more preferably 2 or more, still more preferably 2.5 or more, even more preferably 3 or more, and even still more preferably 3.5 or more. Films also typically have a MDO ratio greater than their TDO ratio in order to be useful in ROSO applications. Films having an MDO of less than 1.2 tend to have insufficient MDO to conform to a container in a ROSO label application. There is no clear upper limit on for MDO ratio, although films typically have a MDO ratio of 20 or less. Films having an MDO ratio greater than 20 risk shrinking around a container in a ROSO label application to such an extent that a glue seem holding the label around the bottle can weaken or fail.

Desirably, films of the present invention have a TDO ratio (ratio of oriented length to un-oriented length in the TD) of more than 1.0. Films having a TDO of 1 tend to suffer from poor integrity upon handling and fracture upon bending. Therefore, some TDO is desirable to enhance film integrity. Extensive TDO hinders the film's performance in ROSO label applications by resulting in contraction of the film and, hence, distortion of the label in the TD. Therefore, films of the present invention typically have a TDO ratio of 2 or less, preferably 1.5 or less, more preferably, 1.2 or less, still more preferably 1.1 or less. The TDO ratio can be 1.05 or less.

Measure MDO ratio and TDO ratio by using a biaxially oriented film sample 5.75 inches (14.6 centimeters) in both MD and TD (that is, square samples). Place the sample in a heated air oven at 120° C. for 10 minutes and then measure MD and TD dimensions again. The ratio of pre-to-post-heated MD and TD dimensions correspond to MDO ratio and TDO ratio, respectively.

Films of the present invention desirably demonstrate a shrinkage at 105° C., preferably at 100° C. of 20% or more, preferably 30% or more, more preferably 40% or more, still more preferably 50% or more in the MD, yet more preferably 60% or more, even yet more preferably 70% or more in the MD. Shrinkage below 20% tends to undesirably limit the extent to which a film can conform to a container contour. While an upper limit on the extent of MD shrink is unknown, it will be below 100%.

Desirably, the films demonstrate a TD shrinkage at 100° C., preferably at 105° C. of 30% or less, preferably 20% or less, more preferably 10% or less in the TD, even more preferably 5% or less. Films of the present invention further desirably demonstrate an absence of growth in the TD at 105° C., preferably at 100° C. (Films that shrink more than 30% or grow in the TD at the specified temperatures tend to complicate conformation of a film to a container in ROSO label applications due to distortions in the TD.) Measure shrinkage according to ASTM method D-1204. Films of the present invention further desirably demonstrate an absence of growth in the TD in test methods according to U.S. Pat. No. 6,897,260 B2.

The presence of the first HIPS component provides films of the present invention with a desirable high clarity and transparency while at the same time enhancing the toughness of the films. Clarity and transparency are desirable in the label industry to provide a non-obscured view of a product around which the label resides. High clarity and transparency are also desirable for “reverse” printing of labels where printing resides between the label and the container and a consumer views the printing through the label. Typically, films of the present invention have clarity values at a film thickness of 2.0 mils (50 μm) of 10 or more, preferably 15 or more, more preferably 20 or more, still more preferably 25 or more, even more preferably 30 or more. Measure clarity according to ASTM method D-1746.

Haze values also provide a measure of a film's clarity, with low haze corresponding to high clarity. Haze values for films of the present invention can range to any conceivable value. However, one advantage of the present invention is the ability to obtain biaxially oriented films with high clarity and low haze. Typical haze values for the present films at a film thickness of 2.0 mils (50 μm) are 10 or less, preferably 8 or less, more preferably 6 or less, most preferably 4 or less. Measure haze according to ASTM method D-1003.

A styrene-based film advantageously has a higher secant modulus than, for example, oriented polypropylene or oriented polyvinyl chloride films. Increasing the secant modulus of a shrink label film is desirable to hinder the films likelihood of stretch during printing. As a result, films of the present invention can run at faster print speeds without risk of film breakage or distortion relative to a film with a lower secant modulus without the first HIPS component. Films of the present invention have a one percent secant modulus in both the MD and TD of 250,000 pounds-per-square-inch (psi) (1,724 MegaPascals (MPa)) or more, preferably, 300,000 psi (2,068 MPa) or more, more preferably 320,000 psi (2,206 MPa) or more. Measure one percent secant modulus by American Society for Testing and Materials (ASTM) method D-882.

Similar to films with high secant modulus, films with a high tensile stress at yield, particularly in the MD, are desirable so that films can run faster and under higher tension in printing processes without stretching than films with a lower tensile stress. Desirably, films of the present invention have a tensile stress at yield of 7000 psi (48 MPa) or more, preferably 8000 psi (55 MPa) or more, more preferably 9000 psi (62 MPa) or more and still more preferably 10,000 psi (69 MPa) or more.

Films of the present invention generally have a thickness of one mil (25 μm) or more, preferably 1.5 mils (38 μm) or more and generally 4 mils (100 μm) or less, preferably 3 mils (76 μm) or less. At a thickness of less than one mil (25 μm), films tend to be undesirably difficult to cut during processing and handling. Thicknesses greater than 4 mils (100 μm) are technically achievable, but generally economically undesirable.

Films of the present invention desirably have an orientation release stress (ORS) of 400 psi (2758 kPa) or less. ORS is a measure of the stress the film experiences during shrinkage upon heating. Lowering ORS values in a ROSO film is desirable. ROSO films typically have at least one end glued to a container around which the film is applied. Labels with high ORS values can apply sufficient stress to a glue seam holding the label around a container during shrinkage so as to damage or break the seam. Lowering ORS values decreases the likelihood that the seam line (film on film) becomes damaged or broken during shrinkage.

Prepare films of the present invention by any means of oriented film manufacture including blown film process and cast-tentering processes. Particularly desirable are blown film processes such as those described in U.S. Pat. No. 6,897,260 and Great Britain Patent (GBP) 862,966 (both of which are incorporated herein by reference).

One suitable process (“Process A”) for preparing films of the present invention is a blown film process using an apparatus as described in U.S. Pat. No. 6,897,260 or GBP 862,966. Feed polymer pellets to the apparatus and convert them to a polymer melt having a temperature within a range of from 170° C. to 100° C.; then cool the polymer melt to a temperature within a range of from 130° C. to 170° C. to increase melt viscosity before extruding the polymer melt through a blown film die into a gaseous atmosphere. Maintain the gaseous atmosphere at a temperature at least 40° C. below the heat distortion temperature of the each polymer composition component(s) (first HIPS component and if present GPPS and/or second HIPS component) in the polymer melt. Blow the extruded polymer melt according to the bubble process of GBP 862,966.

Another possible blown film process (“Process B”) suitable for preparing films of the present invention uses two extruders (Extruder 1 and Extruder 2) in series. Extruder 1 is a 2½ inch (6.35 cm) diameter, 24:1 single screw extruder with five barrel zones, each set at a temperature between 155° C. and 200° C., typically increasing in temperature down the extruder. Extruder 2 is a 3½ inch (8.89 cm) diameter, 32:1 single screw with a barrier mixing screw and five barrel zones, each having temperature set point typically at a temperature from 115° C. and 175° C. Feed polymer pellets into Extruder 1 to plasticize the polymer and pump the polymer to Extruder 2 at a temperature of 200-260° C. The polymer proceeds from Extruder 1 through a transfer line and into the entry port of extruder 2. Cool the polymer in Extruder 2 to a melt temperature (extrusion temperature) of selected between 150-190° C. so as to achieve a stable bubble and to optimize orientation release stress (ORS) properties of the resulting film to a desirable value. Cool the polymer by cooling the walls of Extruder 2. Extrude the polymer from Extruder 2 through a 3.25 inch (8.3 cm) annular die and then through a 4.5 inch (11.4 cm) diameter air ring and blow or expand the polymer into a bubble with a diameter that typically ranges from 9 inches (22.9 cm) to 24 inches (63.5 cm). Use the bubble blowing process of GBP 862,966.

Films of the present invention have utility in any application that benefits from heat triggered shrinkage in the MD. The films have a particular utility as ROSO labels. To convert a film of the present invention into a ROSO label of the present invention cut the film to a desirably width and corona treat a side of the film (in any order) and then print on the corona treated side of the film. Printing can reside on the “reverse” side of the film to create a reverse printed label. The reverse side of the film resides against a container and printing on the reverse side is viewed through the film when the film is around a container in a ROSO label application. These steps are typically done on a continuous web process by any method useful in the art.

Films and labels of the present invention can also advantageously possess perforations through the film or label. Perforations are most desirably located in the portion of a film proximate to the narrowest portion or portions of a container around which the film is applied in a ROSO application. The perforations allow gas that would otherwise tend to become trapped between the label and container to escape, thereby allowing the label to more tightly conform to the container. Films, and labels, of the present invention can contain perforations uniformly distributed across a film surface or contain perforations specifically located proximate to the areas of the film (or label) that will coincide with the narrowest portions of a container around which the film (or label) will reside. Perforation of films and labels of the present invention can be perforated at any time; however, in order to facilitate printing of ROSO labels, desirably perforate films and labels after printing.

The following example serves as an illustration of the present invention and does not serve to establish the full scope of the present invention.

### COMPARATIVE EXAMPLE A

Prepare COMPARATIVE EXAMPLE A (COMP EX A) with a polymer composition comprising 100 wt % GPPS (STYRON® 665, STYRON is a trademark of The Dow Chemical Company), based on film weight. Prepare the film according to “Process B.”

### HIPS-X Component for Examples 1-6

Examples 1-6, below, utilize HIPS-X as a first HIPS component. Produce HIPS-X, for example, in the following continuous process using three agitated reactors working-in series. Prepare a rubber feed solution by dissolving the rubber components of Table 1 into styrene at a rubber component ratio of 1 part Diene 55 to 15 parts Buna 6533 (that is, 0.3 wt % Diene 55 and 4.5 wt % Buna 6533 based on total rubber feed solution weight). Incorporate 2.5 wt % mineral oil (70 centistokes kinematic viscosity) and 7 wt % ethyl benzene with the rubber feed solution to form a feed stream, with wt % relative to total feed stream weight. Add 0.1 wt % Antioxidant Irganox 1076 to provide levels of about 1200 parts per million (ppm) in the final product. The balance of the feed is styrene to 100 wt %. Supply the feed stream to the first reactor at a rate of 750 grams per hour (g/h). Target a rubber blend content in the feed stream and the feed rates of styrene and rubber to a reactor to produce a rubber-modified polystyrene product (HIPS-X) containing 4 wt % butadiene.

Each of the three reactors has three zones with independent temperature control. Use the following temperature profile: 125, 130, 135, 143, 149, 153, 157, 165, 170° C. Agitate at 80 revolutions per minute (RPM) in the first reactor, 50 RPM in the second reactor and 25 RPM in the third reactor. Add 100 ppm of chain transfer agent (n-Dodecyl Mercaptan or nDM) into the second zone of the first reactor.

Use a devolatilizing extruder to flash out residual styrene and ethylbenzene diluent and to crosslink the rubber. The temperature profile for the devolatilizing extruder is 240° C. at the start of the barrel, medium zone of the barrel and final zone of the barrel. The screw temperature is 220° C.

Use the following test methods (or methods defined previously herein) to characterize HIPS-X: Melt Flow Rate: ISO-133. PS Matrix molecular weight distribution: PS calibration Gel Permeation Chromatography. Rubber Particle size: Light scattering using an LS 230 apparatus and software from Beckman Coulter. Tensile Yield, Elongation and Modulus: ISO-527-2.

Determine the gel concentration of HIPS-X by methyl ethyl ketone extraction. For analyzing HIPS-X, dissolve a 0.25 gram sample of HIPS-X into a methyl ethyl ketone/methanol mixture (10:1 volume ratio) by placing the sample and mixture into a tube of known weight and agitating on a wrist shaker for two hours at room temperature (23° C.). Isolate an insoluble fraction by placing the tube in a high speed centrifuge and spinning at 19500 revolutions per minute at 5° C. for one hour. Decant off excess liquid and place the tubes in a vacuum oven at 150° C. for 45 minutes at a vacuum of 2-5 millimeters of mercury. Remove the tubes from the oven and allow to cool to approximately 23° C. Weigh the tubes to determine, subtract the known weight of the tube to determine gel weight. The gel weight divided by 0.25 grams and multiplied by 100 provides the wt % gel content relative to total HIPS-X weight.

TABLE 1

| | Conjugated Diene | Conjugated Diene |
|---|---|---|
| | Copolymer rubber | Hompolymer Rubber |
| Property | Buna BL 6533 T | Diene 55 (Trademark |
| | (trademark of | of Firestone) |
| | Bayer) | |
| Styrene Content (%) | 40 | 0 |
| Vinyl Content (%) | 9 | 11 |
| Cis Content (%) | 38 | 38 |
| Viscosity (Mooney | 45 | 70 |
| viscosity ML1 + 4 100° C. in | | |
| Pascal-Seconds) | | |
| Solution Viscosity (5.43% | 40 | 170 |
| in toluene) milliPascal- | | |
| Seconds | | |
| Polymer Structure | AB Block | Generally linear |
| | copolymer | |

HIPS-X has a volume average rubber particle size of 0.35 μm with 65 vol % of the particle having a size of less than 0.4 μm and 35 vol % of the particles having a size of 0.4-2.5 μm. HIPS-X has a rubber concentration of 0.38 wt % butadiene homopolymer and 5.6 wt % styrene/butadiene copolymer, for a combined rubber concentrations of 5.98 wt % based on HIPS-X weight. HIPS-X has a gel concentration of approximately 8 wt %, relative to total HIPS-X weight. HIPS-X contains 2 wt % mineral oil, has a MFR of 7.0 g/10 min, Vicat temperature of 101° C., Tensile Yield of 20 megapascals (MPa), elongation at rupture of 25% and tensile modulus of 2480 MPa.

### EXAMPLES 1-6

Prepare each of EXAMPLE (EX) 1-6 in a like manner to COMP EX A except use the following polymer compositions, wt % is of total film weight:
EX 1: 80 wt % STYRON 665/20 wt % HIPS-X
EX 2: 65 wt % STYRON 665/35 wt % HIPS-X.
EXs 3-5: 35 wt % STYRON 665/65 wt % HIPS-X.
EX 6: 100 wt % HIPS-X.

The extrusion temperature for each film is in Table 2. For EXs 1-4, and 6 use a blow up ratio of 2.6. For EX 5 use an extrusion temperature of 3.6.

### Results

Table 2 illustrates film properties for COMP EX A and EXs 1-6. Use the following test methods to characterize films throughout the present disclosure. Measure Haze according to ASTM method D-1003. Measure Clarity according to ASTM method D-1746. Measure Tensile Stress and Strain, Toughness and Secant Modulus according to ASTM method D-882. Measures orientation release stress (ORS) according to ASTM method D-2838. Measure Free Air Shrink according to ASTM method D-1204.

TABLE 2

| | COMP EX | EX 1 | EX 2 | EX 3 | EX 4 | EX 5 | EX 6 |
|---|---|---|---|---|---|---|---|
| | A (100% | (80% | (65% | (35% | (35% GPPS w | (35% GPPS w/ | (0% |
| Property | GPPS) | GPPS) | GPPS) | GPPS) | hi temp) | hi BUR) | GPPS) |
| Extrusion | 170 | 170 | 168 | 164 | 177 | 166 | 162 |
| Temperature (° C.) | | | | | | | |
| MDO Ratio | 3.49 | 6.20 | 3.71 | 3.07 | 4.21 | 2.97 | 3.07 |
| TDO Ratio | 1.07 | 1.21 | 1.23 | 1.05 | 1.26 | 1.49 | 1.14 |
| Thickness, mils | 2.04 | 2.45 | 2.43 | 2.23 | 2.25 | 1.84 | 2.34 |
| (μm) | (52) | (64) | (63) | (57) | (57) | (47) | (59) |
| Haze | 4 | 6 | 4 | 6 | 5 | 5 | 8 |
| Clarity | 17 | 12 | 20 | 13 | 15 | 30 | 14 |
| Tensile Stress | 10,960 | 10,860 | 10,340 | 10,540 | 9,770 | 9,520 | 9,400 |
| at Yield, MD, | (76) | (75) | (71) | (73) | (67) | (66) | (65) |
| psi | | | | | | | |
| (MegaPascals) | | | | | | | |
| Tensile Stress | 7,745 | 6,480 | 6,870 | 6,790 | 7,200 | 7,550 | 5,840 |
| at Yield, TD, | (54) | (45) | (47) | (47) | (50) | (52) | (40) |
| psi | | | | | | | |
| (MegaPascals) | | | | | | | |
| 1% Secant | 430,720 | 412,650 | 392,320 | 390,890 | 379,060 | 422,600 | 369,740 |
| Modulus, MD, psi | (3000) | (2800) | (2700) | (2700) | (2600) | (2900) | (2500) |
| (MegaPascals) | | | | | | | |
| 1% Secant | 376,440 | 359,780 | 416,470 | 338,600 | 338,230 | 412,780 | 351,630 |
| Modulus, TD, psi | (2600) | (2500) | (2900) | (2300) | (2300) | (2800) | (2400) |
| (MegaPascals) | | | | | | | |
| ORS 275° F. hot | 503 | 584 | 291 | 376 | 215 | 235 | 253 |
| oil, MD, psi | (3500) | (4000) | (2000) | (2600) | (1500) | (1600) | (1700) |
| (kPa) | | | | | | | |
| ORS 275° F. hot | 17 | 11 | 21 | 3 | 14 | 28 | 8 |
| oil, TD, psi | (120) | (76) | (145) | (21) | (97) | (193) | (55) |
| (kPa) | | | | | | | |
| % Free air | 3 | 9 | 2 | 15 | 7 | 3 | 20 |
| Shrink 95° C. MD | | | | | | | |
| % Free Air | −2 | −3 | −1 | −5 | −2 | −1 | −4 |
| Shrink 95° C. TD | | | | | | | |
| % Free Air | 3 | 18 | 22 | 18 | 13 | 40 | 29 |
| Shrink 100° C. MD | | | | | | | |
| % Free Air | −1 | −5 | −3 | −5 | −2 | 10 | −4 |
| Shrink 100° C. TD | | | | | | | |
| % Free Air | 18 | 48 | 61 | 67 | 71 | 53 | 60 |
| Shrink 105° C. MD | | | | | | | |
| % Free Air | −6 | −10 | 8 | −1 | 12 | 22 | 7 |
| Shrink 105° C. TD | | | | | | | |
| % Free Air | 71 | 74 | 66 | 75 | 67 | 62 | 81 |
| Shrink 110° C., MD | | | | | | | |
| % Free Air | 10 | 6 | 19 | 8 | 15 | 28 | 15 |
| Shrink 110° C., TD | | | | | | | |
| % Free Air | 71 | 84 | 73 | 67 | 76 | 66 | 67 |
| Shrink 120° C., MD | | | | | | | |
| % Free Air | 7 | 17 | 19 | 5 | 20 | 33 | 12 |
| Shrink 120° C., TD | | | | | | | |

EXs 1-6 illustrate films of the present invention spanning a range of GPPS/First HIPS component ratios.

EXs 3-5 illustrate films of the present invention having similar GPPS/First HIPS Component ratios and illustrate how to reduce ORS in the final films by increasing orifice temperature during extrusion (EX 4 relative to EX 3) and by increasing the blow up ration (EX 5 relative to EX 3).

EXs 1-6 also illustrate how adding even 20 wt % of the First HIPS component (based on film weight, which is also polymer composition weight in these examples) increases dramatically the Free Air Shrink in the MD even at 100° C. and 105° C., relative to the GPPS film of COMP EX A.

EXs 2-6 further illustrate films containing 35 wt % or more first HIPS component have a significantly lower ORS than the 100 wt % GPPS film of COMP EX A.

What is claimed is:

1. A biaxially oriented film comprising a polymer composition, said polymer composition consisting of:
(a) a first high impact polystyrene (HIPS) component having:
(i) a block copolymer of styrene and a rubbery conjugated diene, wherein the copolymer is grafted to a polystyrene;
(ii) optionally, two weight-percent or more and 8 weight-percent or less of a rubbery conjugated diene homopolymer based on total rubber weight in the first HIPS component.
(iii) a total diene-component content from the rubber component of one weight percent or more and seven weight percent or less based on total weight of the first HIPS component;
(iv) less than 10 wt % gel concentration by methyl ethyl ketone/methanol extraction;
(v) an average rubber particle size of less than 1.0 micrometers and 0.01 micrometers or more;
(vi) about 40 to about 90 volume percent of the rubber particles with diameters of less than about 0.4 microns and from about 10 to about 60 volume percent of the rubber particles with diameters between about 0.4 and about 2.5 microns;
(vii) a majority of rubber particles with a core/shell morphology;
(viii) a concentration that accounts for 100 percent by weight (wt %) or less and 30 wt % or more relative to the polymer composition weight and that provides one or more and five or less percent by weight of rubbery diene weight relative to total composition weight; and
(b) a general purpose polystyrene having a weight-average molecular weight of more than 200,000 grams per mole and 350,000 grams per mole or less and that is present at a concentration of zero wt % or more and 70 wt % or less relative to the polymer composition weight; and
(c) a second HIPS component different than (a) and that is present at a concentration of zero wt % or more and 20 wt % or less relative to the polymer composition weight;
wherein, the total combination of (a), (b) and (c) accounts for 100 wt % of the polymer composition; the polymer composition accounts for at least 95 wt % of the biaxially oriented film weight with the balance to 100 wt % selected from additives; and wherein the film has a MDO ratio of more than 1.2 and a TDO ratio of 2.0 or less and wherein the MDO ratio is greater than the TDO ratio.

2. The film of claim 1, wherein the first high impact polystyrene component has a volume average rubber particle size of 0.5 micrometers or less and 0.01 micrometers or more.

3. The film of claim 1, wherein the film has a machine direction (MD) and transverse direction (TD) one-percent secant modulus per American Society for Testing and Materials method 882 of 250,000 pounds per square inch (1,724 MegaPascals) or more.

4. The film of claim 1, wherein the amount of second HIPS component is zero weight percent based on film weight.

5. The film of claim 4, wherein the amount of general purpose polystyrene is zero weight percent based on film weight.

6. The film of claim 1, wherein the amount of general purpose polystyrene is zero weight percent based on film weight.

7. The film of claim 1, wherein the rubbery conjugated diene in the copolymer of (a) is a 1,3-alkadiene.

8. The film of claim 1, wherein the rubbery conjugated diene in the copolymer of (a) is butadiene.

9. The film of claim 1, wherein the total rubber concentration is less than 10 weight-percent, based on total film weight.

10. The film of claim 1, wherein the film demonstrates an absence of growth in the transverse direction after 5 minutes in a heated air oven at 11 degrees Celsius.

11. The film of claim 1, wherein 90 percent or more of the rubber particles have a particles have a particle size of less than 0.4 micrometers and the balance of the rubber particles to 100 percent have a particle size of 2.5 micrometers or less.

12. The film of claim 1, wherein the film comprises mineral oil.

13. The film of claim 1, further comprising perforations.

14. A shrink label comprising a biaxially oriented polymer film of claim 1 wherein the film has printing on one or both sides.

15. The shrink label of claim 14, wherein the label is reverse printed.

16. The shrink label of claim 14, further comprising perforations.
